(19) United States
(12) Patent Application Publication
(10) Pub. No.: US 2018/0004328 A1
(43) Pub. Date: Jan. 4, 2018

(54) TOUCH DISPLAY DEVICE

(71) Applicants: BOE TECHNOLOGY GROUP CO., LTD., Beijing (CN); HEFEI BOE OPTOELECTRONICS TECHNOLOGY CO., LTD., Hefei (CN)

(72) Inventors: Honggang GU, Beijing (CN); Xiaohe LI, Beijing (CN); Xianjie SHAO, Beijing (CN); Jie SONG, Beijing (CN)

(21) Appl. No.: 15/521,782

(22) PCT Filed: Sep. 28, 2016
(86) PCT No.: PCT/CN2016/100507

§ 371 Date: Apr. 25, 2017

(30) Foreign Application Priority Data
Jan. 19, 2016 (CN) 201610034489.3

(51) Int. Cl. G06F 3/041; G02F 1/133; G02F 1/1333; G06F 3/044

(52) U.S. Cl. CPC G06F 3/0412; G06F 3/044; G02F 1/13306; G02F 1/13338

(57) ABSTRACT

The present disclosure relates to a touch display device, including a first substrate, a second substrate arranged opposite to the first substrate, a touch pattern, at least one portion of which is arranged on the first substrate, and a touch drive circuit arranged on an edge of one side of the first substrate and connected with the at least one portion of the touch pattern.

### CROSS REFERENCE TO RELATED APPLICATIONS

This application is a National Stage Entry of PCT/CN2016/100507 filed Sep. 28, 2016, which claims the benefit and priority of Chinese Patent Application No. 201610034489.3 filed on Jan. 19, 2016, the disclosures of which are incorporated by reference herein in their entirety as part of the present application.

### BACKGROUND

The embodiments of the disclosure generally relate to a display device, in particular, a touch display device.

At present, as touch panels are gradually penetrating into people's life, traditional input devices are out of people's horizon day by day. Many types of input devices, such as, mouse, button, touch panel, joystick and touch screen and etc., can be currently applied to a computer system for performing operations. Touch screens are becoming more and more popular because of their usability, multifunctionality in operation, falling prices, and stably increased yields.

In general, a conventional liquid crystal touch screen includes a color film (CF) substrate and an array substrate arranged opposite to each other. In order that the touch screen has a good touch function and scratch resistance, a touch pattern for implementing the touch function is generally arranged on the color film substrate. In this case, a touch drive chip (touch IC) is usually arranged on the array substrate, but a display drive chip (driver IC) is also arranged on the array substrate, consequently, a size of the array substrate is increased. What's worse, if both a touch IC and a driver IC are provided on the same substrate, they may interfere with each other, and the touch pattern on the color film substrate and the touch IC on the array substrate cannot be connected easily.

### BRIEF DESCRIPTION

The present disclosure provides a touch display device, which can solve existing problems in the prior art, for example, a size of the array substrate increasing, the driver IC and the touch IC interfering with each other, and the touch pattern on the color film substrate and the touch IC on the array substrate being hardly connectable. The touch display device includes a first substrate, a second substrate arranged opposite to the first substrate, a touch pattern, at least one portion of which is arranged on the first substrate, and a touch drive circuit arranged on an edge of one side of the first substrate and connected with the at least one portion of the touch pattern.

Furthermore, the touch display device further includes a display drive circuit arranged on one side of the second substrate, the one side of the second substrate facing the first substrate.

Furthermore, the display drive circuit is arranged on an edge of the one side of the second substrate.

Furthermore, the at least one portion of the touch pattern extends to the outside of a display area of the touch display device.

Furthermore, the at least one portion of the touch pattern is bonded with the touch drive circuit.

Furthermore, the touch pattern is entirely located on a surface of the first substrate, the surface of the first substrate facing the second substrate.

Furthermore, the touch pattern includes a transmitting electrode layer and a receiving electrode layer, wherein the transmitting electrode layer is located on a surface of the first substrate, and the receiving electrode layer is located on another surface of the first substrate, the another surface opposing the surface.

Furthermore, the touch pattern includes a transmitting electrode layer and a receiving electrode layer, wherein the transmitting electrode layer is located on a surface of the first substrate, and the receiving electrode layer is located on a surface of the second substrate, the surface of the second substrate being opposite to the surface of the first substrate.

The touch display device provided by the present disclosure eases an connection between the touch pattern and the touch IC on the color film substrate side, reduces a size of the array substrate, and mitigates interferences between the driver IC and the touch IC, moreover, the touch display device has advantages of a good touch function, no vanishing, good scratch resistance, and mitigation of interferences with the thin-film transistor (TFT).

### BRIEF DESCRIPTION OF THE DRAWINGS

In order to illustrate the technical solutions of the embodiments of the disclosure more clearly, a brief introduction to figures of the embodiments is made as follows. The figures described below merely relate to some embodiments of the disclosure, but do not limit the disclosure. A person skilled in the art may obtain other figures based on these figures. When reading in combination with figures, a person skilled in the art, by referring to the following detailed description to the illustrative embodiments, may better understand respective aspects of the embodiments of the disclosure as well as further purpose and advantages thereof. In the figures,

FIG. 1 is a schematic diagram illustrating a plan view of a touch display device according to exemplary embodiments of the disclosure;

FIG. 2 is a schematic diagram illustrating a profile, taken along a longitudinal direction of FIG. 1, of the touch display device according to exemplary embodiments of the disclosure;

FIG. 3 is a schematic diagram further illustrating a structure of a touch pattern in the touch display device shown in FIG. 2;

FIG. 4 is a schematic diagram further illustrating another structure of a touch pattern in the touch display device shown in FIG. 2; and

FIG. 5 is a schematic diagram further illustrating a further structure of a touch pattern in the touch display device shown in FIG. 2.

### DETAILED DESCRIPTION

In order to make the purposes, technical solutions and advantages of the embodiments of the disclosure clearer, a clear and complete description to the technical solutions of the disclosure shall be made in combination with figures of the embodiments of the disclosure. The embodiments to be described below are only some of embodiments, but not all the embodiments. Based on the described embodiments of the disclosure, a person skilled in the art may obtain some other embodiments without creative work, but all the other embodiments shall fall within the protection scope of the disclosure.

Throughout the description, features, advantages or similar expressions involved in the text of the description do not mean that all the features and advantages that are achievable by the disclosure should be or are in any single embodiment of disclosure. On the contrary, it should be understood that the features, advantages and similar expressions mean that specific features, advantages or characteristics described in conjunction with embodiments are included in at least one embodiment of the disclosure. On this sense, discussions on features and advantages or similar expressions throughout the description may indicate the same embodiment, but do not necessarily indicate the same embodiment. In addition, the described features, advantages and characteristics of the disclosure may be integrated in one or more embodiment in any appropriate manner. A person skilled in the art will be aware that the disclosure may be implemented without one or more specific features or advantages of a specific embodiment. In other examples, some additional features and advantages implementable in some embodiments may not necessarily appear in all embodiments of the disclosure.

In the description to the embodiments of the disclosure, it needs to be explained that directional or positional relations indicated by the terms “up”, “down”, “top”, “bottom” and so on are based on directional or positional relations shown by the figures. These terms are used to merely facilitate the description to the disclosure and to simplify the description, but do not indicate or suggest that corresponding devices or elements must have specific directions and positions, or must be structured or operated in the specific directions and positions. Thus, those terms should not be considered to limit the disclosure.

In addition, “a plurality of” means two or more in the description of the disclosure, unless it is otherwise explained.

According to exemplary embodiments of the disclosure, the term “touch” and other similar terms can be interchangeably used to express direct and/or indirect contact with and/or control of input devices, such as, display screen and the like. Use of any such terms should not be considered to limit spirit and scope of the embodiments of the disclosure.

A touch display device may enable a user to slightly touch a display screen with a finger, a touch pen and etc., for example, performing an operation by causing a change in self-capacitance or mutual capacitance formed by a touch pattern in a corresponding position, thereby freeing the user from a keyboard and a mouse to perform operations more conveniently.

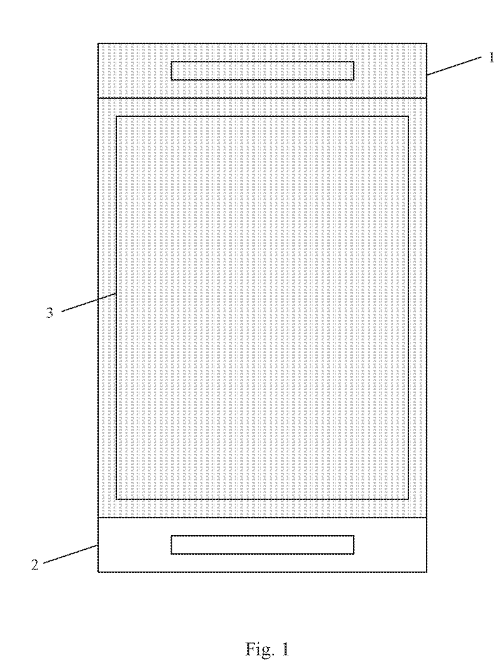

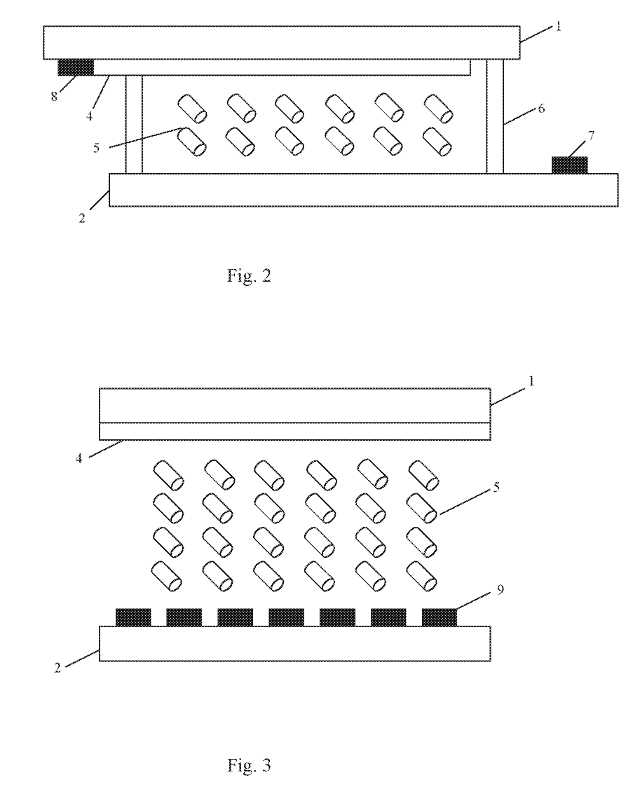

FIG. 1 is a schematic diagram illustrating a plan view of a touch display device according to exemplary embodiments of the disclosure. FIG. 2 is a schematic diagram illustrating a profile, taken along a longitudinal direction of FIG. 1, of the touch display device according to exemplary embodiments of the disclosure. However, a person skilled in the art can understand that a drive circuit may be provided along a lateral direction of a display area shown in FIG. 1, at this time, a profile may be taken along this lateral direction.

Referring to FIG. 2, the touch display device includes a color film substrate 1, an array substrate 2 arranged opposite to the color film substrate 1, a touch pattern 4, at least one portion of which is arranged on the color film substrate 1, a liquid crystal layer 5 located between the color film substrate 1 and the array substrate 2, and surrounded by a sealant 6 to form a display area 3, a display drive circuit 7 arranged on one side of the array substrate 2, the one side of the array substrate 2 facing the color film substrate 1, and a touch drive circuit 8 arranged on an edge of one side of the color film substrate 1 and connected with the at least one portion of the touch pattern 4. In FIG. 1, the shadow area represents a region where the color film substrate 1 is located, and the non-shadow area represents a region of the array substrate 2 not overlapping the color film substrate 1.

More specifically, as shown in FIG. 2, the display drive circuit 7 is arranged on an edge of one side of the array substrate 2, the one side facing the color film substrate 1.

It should be noted that gate lines, data lines, thin-film transistors, pixel electrodes and so on are conventional settings in the art, so they are neither shown here, nor are described in details.

As shown in FIG. 2, in the case that at least one portion of the touch pattern 4 is arranged on the color film substrate 1, the touch drive circuit 8 is also arranged on the color film substrate 1, which eases an connection between the touch pattern and the touch drive circuit (i.e., touch IC) on the color film substrate side, lowers the technical difficulty in connection between the touch drive circuit and the touch pattern, and reduces a longitudinal size of the array substrate, moreover, the touch drive circuit and the display drive circuit (i.e., Driver IC) are arranged on different substrates, respectively, to mitigate their interferences with each other.

As shown in FIG. 2, with respect to the liquid crystal layer 5 (display area 3 in FIG. 1), the touch drive circuit 8 is located on an opposite side of the display drive circuit 7, which may further reduce interferences between the touch drive circuit and the display drive circuit, reduce a longitudinal size of the color film substrate at the same side with the array substrate, and make it feasible to provide a touch key area and a display key area on the opposite sides of the display area 3, as indicated by FIG. 1. However, a person skilled in the art can understand that a relative positional relation between the touch drive circuit and the display drive circuit is not limited to this, for instance, the touch drive circuit and the display drive circuit respectively arranged on different substrates may be provided on the same side of the liquid crystal layer 5 (display area 3 in FIG. 1) and etc., as long as the touch drive circuit is arranged on or near the color film substrate, such that it is easy to connect the touch drive circuit and the touch pattern on the color film substrate side.

As shown in FIG. 2, the at least one portion of the touch pattern 4 arranged on the color film substrate 1 extends to the outside of a display area of the touch display device, i.e., extending to the outside of the sealant 6, to facilitate its connection with the touch drive circuit 8 and decrease wiring. However, a person skilled in the art can understand that the touch pattern 4 may not directly extend to the outside of the display area, but may be connected to the touch drive circuit 8 by wiring buried in the color film substrate, and so forth.

As shown in FIG. 2, the touch pattern 4 extending to the outside of the display area is bonded with the touch drive circuit 8, for example, via a conductive adhesive. That is, the touch pattern and the touch drive circuit are directly connected with each other. However, a person skilled in the art can understand that the touch pattern 4 extending to the outside of the display area may be connected with the touch drive circuit 8 via a wire or a conduction band, or the like.

It is mentioned in the aforesaid exemplary embodiments that at least one portion of the touch pattern 4 is arranged on the color film substrate 1, which facilitates its connection with the touch IC on the color film substrate side, and has advantages of a good touch function, no vanishing, good scratch resistance, and mitigation of interferences with the thin-film transistor (TFT). In conjunction with FIGS. 3, 4 and 5, the following description is made to several structures of the touch pattern 4 provided for its easy connection with the touch drive circuit 8 arranged on the color film substrate 1 and for its aforesaid advantages. However, a person skilled in the art can understand that structures of the touch pattern in the touch display device according to exemplary embodiments of the disclosure are not limited to those shown in FIGS. 3, 4 and 5, as long as at least one portion of the touch pattern 4 is arranged on or near the color film substrate 1.

FIG. 3 is a schematic diagram illustrating a structure of a touch pattern in the touch display device according to exemplary embodiments of the disclosure. Referring to FIG. 3, the touch pattern 4 is entirely located on a lower surface of the color film substrate 1, the lower surface of the color film substrate 1 facing the array substrate 2. This is merely one example showing that a touch pattern is entirely located on the same surface of a color film substrate.

Under such a setting, the touch pattern 4 may be connected with the touch drive circuit 8 arranged on the color film substrate 1, for example, by wiring buried in the color film substrate or the like, or may directly extend to the outside of the display area to connect with the touch drive circuit 8 arranged on the color film substrate 1 via a conductive adhesive, a wire or a conduction band or the like, which facilitates its connection with the touch IC on the color film substrate side, thereby lowering the technical difficulty in connection between the touch drive circuit and the touch pattern, and having advantages of a good touch function, no vanishing, good scratch resistance, and mitigation of interferences with the thin-film transistor (TFT).

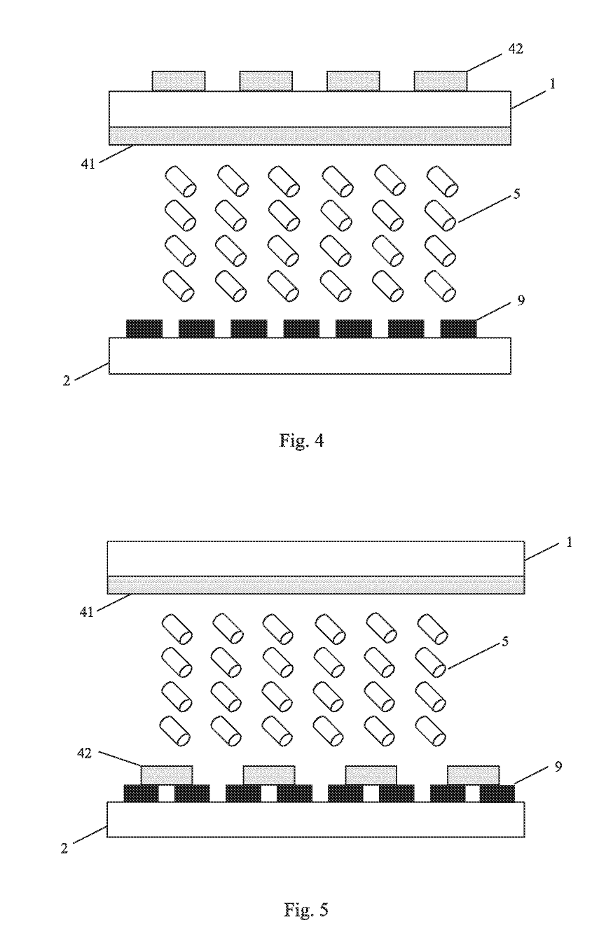

FIG. 4 is a schematic diagram illustrating another structure of a touch pattern in the touch display device according to exemplary embodiments of the disclosure. Referring to FIG. 4, the touch pattern includes a transmitting electrode layer 41 and a receiving electrode layer 42, wherein the transmitting electrode layer 41 is located on a lower surface of the color film substrate 1, the lower surface of the color film substrate 1 being opposite to the array substrate 2, and the receiving electrode layer 42 is located on an upper surface of the color film substrate 1. This is merely one example showing that a transmitting electrode layer and a receiving electrode layer of a touch pattern are respectively arranged on different surfaces of a color film substrate.

Under such a setting, at least one of the transmitting electrode layer 41 and the receiving electrode layer 42 may be connected with the touch drive circuit 8 arranged on the color film substrate 1, for example, by wiring buried in the color film substrate or the like, or may directly extend to the outside of the display area to connect with the touch drive circuit 8 arranged on the color film substrate 1 via a conductive adhesive, a wire or a conduction band or the like, which facilitates its connection with the touch IC on the color film substrate side, thereby lowering the technical difficulty in connection between the touch drive circuit and the touch pattern, and having advantages of a good touch function, no vanishing, good scratch resistance, and mitigation of interferences with the thin-film transistor (TFT).

FIG. 5 is a schematic diagram illustrating a further structure of a touch pattern in the touch display device according to exemplary embodiments of the disclosure. Referring to FIG. 5, the touch pattern includes a transmitting electrode layer 41 and a receiving electrode layer 42, wherein the transmitting electrode layer 41 is located on a lower surface of the color film substrate 1, the lower surface of the color film substrate 1 being opposite to the array substrate 2, and the receiving electrode layer 42 is located on a surface of the array substrate 2, the surface of the array substrate 2 being opposite to the lower surface of the color film substrate 1. More specifically, as shown in FIG. 5, the receiving electrode layer 42 is arranged on a thin-film transistor layer 9 on the array substrate 2, and is opposite to the transmitting electrode layer 41. This is merely one example showing that a transmitting electrode layer and a receiving electrode layer of a touch pattern are respectively arranged on different substrates.

Under such a setting, at least one portion of the touch pattern, such as, the transmitting electrode layer 41, may be connected with the touch drive circuit 8 arranged on the color film substrate 1, for example, by wiring buried in the color film substrate or the like, or may directly extend to the outside of the display area to connect with the touch drive circuit 8 arranged on the color film substrate 1 via a conductive adhesive, a wire or a conduction band or the like, which facilitates its connection with the touch IC on the color film substrate side, thereby lowering the technical difficulty in connection between the touch drive circuit and the touch pattern, and having advantages of a good touch function, no vanishing, good scratch resistance, and mitigation of interferences with the thin-film transistor (TFT).

The touch display device according to exemplary embodiments of the disclosure is described in combination with FIGS. 1-5. It is particularly notable that, in order to understand the disclosure in reference to figures, the descriptive expressions concerning direction, location and position in the aforesaid exemplary embodiments are based on specific placement posture of the touch display device in FIGS. 1-5, arrangement orientation of a drive circuit thereof and viewing angles of an observer. However, a person skilled in the art should understand that when there are changes in placement posture (e.g., horizontally or vertically placed) of the touch display device, arrangement orientation (e.g., arranged along a lateral or longitudinal direction of the display area) of a drive circuit thereof and viewing angles (e.g., down-looking, forward-looking, or side-looking and etc.) of an observer, the descriptive expressions concerning direction, location and position in the above exemplary embodiments can be adjusted accordingly. The adjustments neither break away from spirit and essence of the disclosure, nor exceed the protection scope of the disclosure.

In combination with figures, the exemplary embodiments of the disclosure are described above, but these are merely exemplary and schematic illustrations adopted in order to describe and expound a concept of the disclosure, but do not constitute restrictions on respective aspects of the disclosure. A person skilled in the art can understand that, while not breaking away from spirit and essence of the disclosure, various modifications and variations may be made to the disclosure, all of which shall fall within the protection scope of the disclosure. The aforesaid descriptions are merely exemplary embodiments of the disclosure, but do not limit the protection scope of the disclosure. The protection scope of the disclosure is subject to the enclosed claims.

1. A touch display device, comprising:
a first substrate;
a second substrate arranged opposite to the first substrate;
a touch pattern, at least one portion of which is arranged on the first substrate; and
a touch drive circuit arranged on an edge of one side of the first substrate and connected with the at least one portion of the touch pattern.

2. The touch display device according to claim 1, further comprising a display drive circuit arranged on one side of the second substrate, the one side of the second substrate facing the first substrate.

3. The touch display device according to claim 2, wherein the display drive circuit is arranged on an edge of the one side of the second substrate.

4. The touch display device according to claim 1, wherein the at least one portion of the touch pattern extends to the outside of a display area of the touch display device.

5. The touch display device according to claim 4, wherein the at least one portion of the touch pattern is bonded with the touch drive circuit.

6. The touch display device according to claim 1, wherein the touch pattern is entirely located on a surface of the first substrate, the surface of the first substrate facing the second substrate.

7. The touch display device according to claim 1, wherein the touch pattern comprises a transmitting electrode layer and a receiving electrode layer, wherein the transmitting electrode layer is located on a surface of the first substrate, and the receiving electrode layer is located on another surface of the first substrate, the another surface opposing the surface.

8. The touch display device according to claim 1, wherein the touch pattern comprises a transmitting electrode layer and a receiving electrode layer, wherein the transmitting electrode layer is located on a surface of the first substrate, and the receiving electrode layer is located on a surface of the second substrate, the surface of the second substrate being opposite to the surface of the first substrate.

9. The touch display device according to claim 2, wherein the at least one portion of the touch pattern extends to the outside of a display area of the touch display device.

10. The touch display device according to claim 3, wherein the at least one portion of the touch pattern extends to the outside of a display area of the touch display device.

11. The touch display device according to claim 2, wherein the touch pattern is entirely located on a surface of the first substrate, the surface of the first substrate facing the second substrate.

12. The touch display device according to claim 3, wherein the touch pattern is entirely located on a surface of the first substrate, the surface of the first substrate facing the second substrate.

13. The touch display device according to claim 4, wherein the touch pattern is entirely located on a surface of the first substrate, the surface of the first substrate facing the second substrate.

14. The touch display device according to claim 5, wherein the touch pattern is entirely located on a surface of the first substrate, the surface of the first substrate facing the second substrate.

15. The touch display device according to claim 2, wherein the touch pattern comprises a transmitting electrode layer and a receiving electrode layer, wherein the transmitting electrode layer is located on a surface of the first substrate, and the receiving electrode layer is located on another surface of the first substrate, the another surface opposing the surface.

16. The touch display device according to claim 3, wherein the touch pattern comprises a transmitting electrode layer and a receiving electrode layer, wherein the transmitting electrode layer is located on a surface of the first substrate, and the receiving electrode layer is located on another surface of the first substrate, the another surface opposing the surface.

17. The touch display device according to claim 4, wherein the touch pattern comprises a transmitting electrode layer and a receiving electrode layer, wherein the transmitting electrode layer is located on a surface of the first substrate, and the receiving electrode layer is located on another surface of the first substrate, the another surface opposing the surface.

18. The touch display device according to claim 2, wherein the touch pattern comprises a transmitting electrode layer and a receiving electrode layer, wherein the transmitting electrode layer is located on a surface of the first substrate, and the receiving electrode layer is located on a surface of the second substrate, the surface of the second substrate being opposite to the surface of the first substrate.

19. The touch display device according to claim 3, wherein the touch pattern comprises a transmitting electrode layer and a receiving electrode layer, wherein the transmitting electrode layer is located on a surface of the first substrate, and the receiving electrode layer is located on a surface of the second substrate, the surface of the second substrate being opposite to the surface of the first substrate.

20. The touch display device according to claim 4, wherein the touch pattern comprises a transmitting electrode layer and a receiving electrode layer, wherein the transmitting electrode layer is located on a surface of the first substrate, and the receiving electrode layer is located on a surface of the second substrate, the surface of the second substrate being opposite to the surface of the first substrate.
